(19) United States
(12) Patent Application Publication
(10) Pub. No.: US 2006/0134578 A1
(43) Pub. Date: Jun. 22, 2006

(54) Medical treatment device

(76) Inventor: Heribert Schmid, Grobenzell (DE)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/513,086

(22) PCT Filed: Apr. 1, 2003
(86) PCT No.: PCT/EP03/03386

§ 371 Date: Jun. 13, 2005

(30) Foreign Application Priority Data
Apr. 29, 2002 (DE) 102 19 166.2

(51) Int. Cl. A61C 1/02

(52) U.S. Cl. 433/101

(57) ABSTRACT

The invention concerns a medical treatment device comprising a pedal driven control unit (20) and a handpiece (30) designed for a medical instrument, said handpiece being adapted to be controlled via said pedal-driven control unit. Said handpiece comprises monitoring devices (32, 33, 34, 35) for controlling data for operating the medical instrument (41), said data capable of being processed in a computer system (22), installed in the pedal-driven control unit (20) and exchanging data with said handpiece (30).

The present invention relates to a medical treatment device. In particular, the present invention relates to a dental treatment device, such as, for instance, a treatment station provided with an endo-drill.

Electrically driven drills are used especially in dentistry for dental therapy as so-called medical endo-instruments. The drill is driven by an electric motor, wherein the drill is supported, for instance, in a dental angle attached to a handpiece of a treatment device.

According to the prior art as disclosed, e.g., in the document DE 198 20 639 A1, the drill is driven by a step motor. By an appropriate control means for the step motor an admissible torque load limit and/or an admissible speed range of the respectively employed drill can be monitored and controlled. The control is performed via the current intensity applied and the rotary field sequence.

Comprehensive experiments furnished the result that by a step motor as drive for presently known endo-instruments the interruption of the latter in practical use is prevented. In this context, the effect of “falling out of step” of step motors, which at the most causes a standstill of the motor in the case of overload, is exploited. The effort in terms of control is extremely small and is substantially restricted to adjusting the current intensity and the pulse generation for the step motor.

In other words, this development permits the enlarged use of electric drives in instruments having a low breaking load while the risk of a break of the instrument is considerably reduced. Thus, it is possible to use an instrument several times. It has now turned out that the breaking load limits for endo-instruments and/or endo-drills established by the inventor in the meantime are subjected to changes as the time of use increases. Within the framework of tests, it was thus possible to establish for some endo-instruments, by way of analysis, a maximum time of use within which the breaking probability is low and the cutting ability of the instruments is sufficient. When this maximum time of use was exceeded, an increased number of breaks had occurred as a result of material fatigue, and the cutting performance achieved had considerably deteriorated.

In order to be able to fully exploit the capacity and the safety potential of the drive concept newly developed by the inventor, it is necessary to have as exact as possible a knowledge of the state of the instrument used to prevent a break at any rate, not as a result of inappropriate use (overload) but as a result of material fatigue due to too long a use. Moreover, it is necessary to make the information about the state of an instrument available to the user in a manner as simple and safe as possible.

As disclosed in another prior art according to DE 198 20 640 A1, a magazine for different instruments is prepared in which the instruments are stored according to numbers or other encodings. For different types of medical treatment, magazines having various drills can be prepared which are inserted in the magazine in predetermined orders. The order and type of the drills as well as the operating parameters of the individual drills can be entered in a computer of a managing apparatus and can be administered there. The managing apparatus may also be a PC.

It is the object of the invention to provide a medical treatment device by which the safety of a medical treatment can be increased while at the same time the application is simplified.

This object is achieved according to the invention by a medical treatment device comprising the features of claim 1.

In accordance with the invention, a medical treatment device comprising a foot-operable (pedal-driven) control unit and a handpiece is provided for a medical instrument, wherein the handpiece is adapted to be controlled via the foot-operable control unit. This medical treatment device is moreover characterized by the fact that the handpiece includes monitoring means for monitoring information of use about the medical instrument which can be processed in a computer system provided in the foot-operable control unit and exchanging data with the handpiece.

According to another preferred embodiment of the invention, the information of use includes the position of the instrument at the magazine, an instrument-specific maximum load accumulation and/or a partial load accumulation. Thus, information improving the operating safety and the application during treatment can be made available. The information of use also may include the type, the structure, the use parameters and other information relating to the drill itself as well as the number of admissible and/or previously performed treatment cycles.

In accordance with another preferred embodiment of the invention, the monitoring means may include a display system (32), an encoding system, a confirmation means and a microcomputer which interact with each other and with the computer system. By the monitoring means, it is not only possible to output the state of the instrument via the information of use, but various pieces of treatment information can be input and output, as well. Furthermore, it is rendered possible by the monitoring means to transmit the data regarding the instrument or the instruments in a magazine to the latter and/or to read them out of the latter.

According to another preferred embodiment of the invention, the encoding system includes a means for identifying encodings of a magazine and for varying the encodings taking the information of use concerning the instrument into account. The means is suited for identifying and/or creating fixed encodings of the magazine which are suited for identifying a particular magazine. Moreover, the means can identify encodings and/or fixed encodings which can be stored in a transponder fixedly arranged at the magazine as data carrier element.

According to a further preferred embodiment of the invention, the instrument is a dental drill, preferably an endo-drill.

In accordance with another preferred embodiment of the invention, the foot-operable control unit is adapted to be controlled by a foot-operable additional control unit which can be connected to the former. This additional control unit can be linked to the foot-operable control unit via a connecting cable or a wireless connection.

According to another preferred embodiment of the invention, a computer-aided data processing system can be connected to the medical treatment device, preferably to the foot-operable control unit. It is achieved in this way that data can be transmitted to the computer system and/or the microcomputer and/or can be read in by the treatment device. So the treatment device can be appropriately adapted to different requirements.

According to another preferred embodiment of the invention, the microcomputer and/or the computer system is/are provided for processing the data relating to the information of use. Magnitudes from which parameters concerning the information of use are determined can be processed so that the function of the treatment device is safeguarded without any further computer system. Consequently, the treatment device according to the invention is an independent system.

According to another preferred embodiment of the invention, the data transmission between the handpiece and the foot-operable control unit is permitted via a connecting line.

Further embodiments of the invention are defined in the dependent claims.

The invention will be explained in detail by way of embodiments with reference to the enclosed drawings, in which

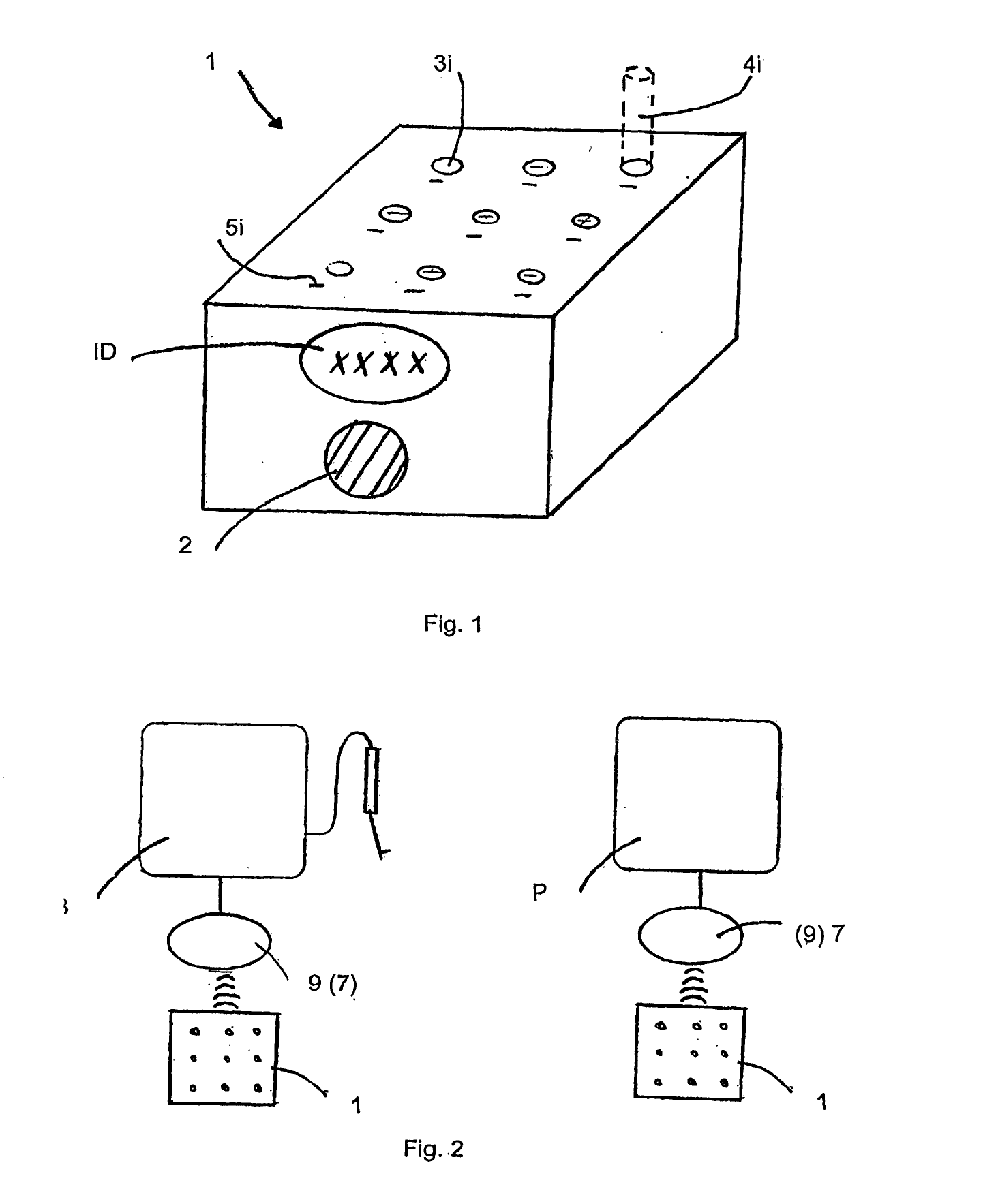

FIG. 1 shows an embodiment of the magazine according to the invention,

FIG. 2 shows an embodiment of a system according to the invention including the magazine according to FIG. 1 and devices for identifying and varying the encodings of the magazine,

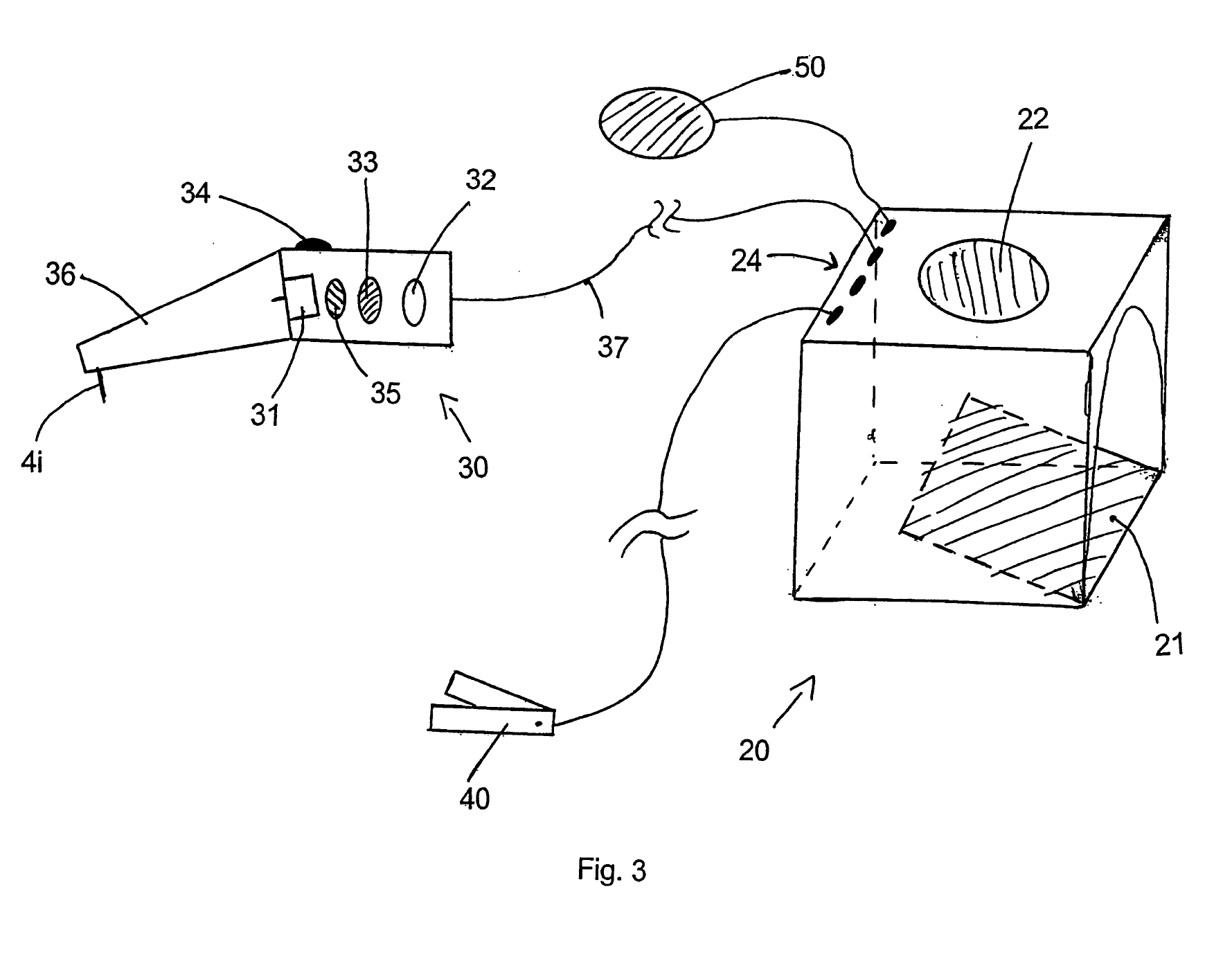

FIG. 3 is a schematic representation of the structure of an embodiment of the medical treatment device according to the invention.

At first, the magazine of the invention, which can be used with the medical treatment device according to the invention, is illustrated according to an embodiment with reference to FIG. 1. The magazine 1 consists of a stable body at the upper side of which holes 3i are provided. The inner diameters of the holes 3i are selected such that drills 4i can be inserted into the holes tip first and can be stored in this way in the magazine.

On one side, the magazine bears an identification mark ID by which each magazine is marked as a unique specimen. Moreover, at each individual hole 3i on the upper side, a discrimination marking 5i is likewise visibly arranged so that each individual hole can be discriminated from the other holes. These discrimination markings may have different colors, ciphers, letters or other characters.

Moreover, at least one transponder 2 is arranged at the body 1 of the magazine. The transponder 2 is fixedly attached to the body 1 of the magazine. The transponder 2 includes a data storage element containing data which are invariable and/or variable. The invariable data or the fixed encodings in the data storage element relate, for instance, to the identification mark of the magazine. This mark is determined once, for instance during manufacture of the magazine 1 with the transponder 2. The visible identification mark need not necessarily correspond to the stored mark of the magazine. The variable data in the data storage element include information concerning the drills stored in the magazine. Hereinafter, the course of action when using the drills will be discussed in detail with reference to FIG. 2 for explaining the information concerning the drills.

FIG. 2 shows an embodiment of a system according to the invention including the magazine according to FIG. 1 and devices for identifying and varying the encodings of the magazine which are connected to a treatment apparatus and a managing apparatus for the data transmission.

For preparing a magazine 1, this magazine is preferably equipped with different drills 4i for a particular treatment procedure. The equipment and the order of the drills for the magazine 1 can be taken from a program by entering the selected treatment procedure into a computer-aided managing apparatus P. The drills are inserted into the magazine at the predetermined positions either manually corresponding to the data of the program, or an already prepared magazine which corresponds to the requirements is provided. Via a device 7 the data concerning the drills are transmitted to the data storage element. To this effect, the magazine 1 including the transponder 2 is brought into the vicinity of the device 7 and thereby the information is exchanged between the device 7 and the transponder 2. Thus, the magazine 1 is ready for use during the treatment. For this purpose, the magazine is provided at a treatment device B.

The data storage element of the transponder 2 at this moment contains, apart from the identification mark, information concerning the type and position of individual drills, the previous accumulated load of each individual drill. The accumulated load of a drill includes the duration and the type of load of the drill to which a drill has been exposed up to the current point in time. The load can be theoretically determined, for instance, from values for the number of revolutions performed, the torque, the service life and the number of sterilizing cycles. Moreover, information concerning the admissible accumulated load which must not be exceeded during treatment is provided with respect to a drill.

At the beginning, the doctor in charge selects the planned treatment procedure at the treatment device. The data in the data storage element of a magazine are then read into the treatment device whereby both the ID of the selected magazine and the data concerning the drills of the magazine are made accessible to the treatment device. For reading in the information of the data storage element, the magazine is brought into the vicinity of the device 9.

After the instrument, for instance a flexible spiral drill for a root-canal preparation, has been inserted into the handpiece and the computer of the treatment device has been informed about the instrument used, the doctor begins with the treatment by starting the drive apparatus. Upon starting the drive apparatus, the computer of the treatment device continuously evaluates, for instance, the operating time, the current intensity as initial value for determining the load intensity, the speed and/or, in the case of a step motor, the number of cycles as reference value of revolutions performed and stores this evaluation as status-specific values in an intermediate memory. In addition, it is provided that the treatment cycles and/or the sterilization cycles are counted and stored especially for a selected one or for all drills.

After completion of the treatment, the doctor switches off the drive apparatus or alternatively enters a termination signal into the treatment device to inform the latter of the end of treatment. The computer now evaluates the measured and stored status-specific values representing a load profile for the previous treatment and herefrom calculates an accumulated theoretical partial load. This partial load is now added to an accumulated total load of possibly preceding treatments using the same instrument so as to update the accumulated total load for this instrument. These data are then transmitted into the storage element of the magazine 1 via the device 9.

The instrument used by the doctor is returned into the magazine again after treatment. The magazine and the instruments are subsequently cleaned and subjected to a sterilizing operation. It has turned out in tests that this sterilizing operation attacks the instruments and results in an accelerated ageing of the material, especially in a blunting of the instruments. For this reason, also the number of sterilizing cycles is evaluated and stored in the storage element of the magazine.

After updating the actual status-specific values, especially the total number of sterilizing cycles and the total load, the treatment system now compares these actual values with the maximum admissible instrument-specific values for the instrument used and outputs a warning signal which informs the doctor of the necessary exchange of this instrument upon reaching or exceeding one of the maximum values. In this case, the doctor will no longer put the instrument into the magazine, but will replace it by a new one.

As is evident from the foregoing description, in this embodiment the actual state of the instrument is determined and compared to the maximally admissible state not before the completion of a treatment. However, the case may occur that already in the course of a treatment for instance the maximum time of use, i.e. the predetermined maximum total load quantity is reached or even exceeded. In order to solve this problem in a simple manner, according to the preferred embodiment, a safety factor which is selected such that this actual maximum load quantity cannot be reached within the scope of an average treatment with the respective instrument, is included when determining the maximum total load quantity.

An embodiment of the medical treatment device according to the invention is described hereinafter with reference to FIG. 3. The medical treatment device described in the following can be used together with the afore-described magazine 1. Moreover, the medical treatment device may include the device 7, 9 for receiving the magazine 1. When describing the following embodiment, the exact explanation of the magazine 1 and the device 7, 9 will therefore be dispensed with.

As one can take from FIG. 3, the medical treatment device according to the invention mainly shows a foot-operable control unit 20 and a treatment hand device or handpiece 30. An angle 36 suited for receiving the drill 4i can be attached to the handpiece. The control unit 20 consists of a stable body at which a foot-operable pedal 21 is arranged. At the housing of the control unit 20 there is arranged an opening in which a user of the foot-operable control unit 20 can position his/her foot so that he/she can operate the pedal by the foot, but at the same time the control unit 20 can be shifted by the foot. The control unit 20 moreover includes a computer system 22 which will be described hereinafter.

The handpiece 30 comprises a motor 31 as already described in the foregoing. On the whole, the handpiece 30 has the functions as described in the preceding embodiment. Furthermore a display system 32, an encoding system 33, a microcomputer 35 and a confirming means 34 are provided at the handpiece 30.

The display system 32 includes a display which is connected to the microcomputer 35. The microcomputer 35 is moreover connected to the confirming means 34 which is provided in the form of a key button/detector at the handpiece 30. By this design the user can, for instance, confirm the exchange of a drill after having selected on the display which drill is concerned. In addition, the display can provide the user with information regarding the state of the drill in interaction with the microcomputer 35.

The encoding system 33 in this case corresponds to the means for identifying encodings of the magazine 1 and for varying the encodings taking information of use about the instrument into account. This means and the information have been described in detail in the foregoing, therefore an exact description is dispensed with. By the encoding system 33 provided at the handpiece the data can be transmitted to the magazine 1 and/or read out of the latter in a manner obvious to the user.

The handpiece 30 and the foot-operable control unit 20 are connected to a transmission line. Thus, the control unit 20 and the handpiece 30 include all elements which allow a function according to the invention. By the inventive arrangement of the above-described elements of the medical treatment system, the system can be simplified and especially further information input and/or output devices can be dispensed with, because the computer system 22 is accommodated in the foot-operable control unit 20.

Furthermore, various terminals 24 are provided at the control unit 20, which serve, for instance, for the power supply of the treatment device, ensure a necessary water and/or air supply of the treatment device or through which data can be transmitted to a further element of the treatment device.

In particular, it is possible to connect to the control unit 20 an additional foot-operable control unit 40 which, however, does not include the computer system 22. This additional foot-operable control unit 40 increases the flexibility of the total arrangement. Moreover, further special functions including the pertinent devices, such as a root-canal depth measuring device, can be provided in the foot-operable control unit 40.

1. A medical treatment device comprising a foot-operable control unit (20) and a handpiece (30) for a medical instrument (4i), said handpiece (30) being adapted to be controlled via said foot-operable control unit (20),
characterized in that
said handpiece (30) includes monitoring means (32, 33, 34, 35) for monitoring information of use about said medical instrument (4i) which can be processed in a computer system (22) provided in said foot-operable control unit (20) and exchanging data with said handpiece (30).

2. A medical treatment device according to claim 1,
characterized in that
the information of use includes the position of said instrument (4i) at the magazine (1), an instrument-specific maximum load accumulation and/or a partial load accumulation.

3. A medical treatment device according to claim 1,
characterized in that
said monitoring means (32, 33, 34, 35) include a display system (32), an encoding system (33), a confirmation means (34) and a microcomputer (35) which interact with each other and with the computer system (22).

4. A medical treatment device according to claim 2,
characterized in that
said monitoring means (32, 33, 34, 35) include a display system (32), an encoding system (33), a confirmation means (34) and a microcomputer (35) which interact with each other and with the computer system (22).

5. A medical treatment device according to claim 3,
characterized in that
said encoding system (33) includes a means for identifying encodings of a magazine (1) and for varying the encodings taking information of use concerning said instrument (4i) into account.

6. A medical treatment device according to claim 5,
characterized in that
said means is capable of identifying and/or creating fixed encodings of said magazine (1) which are suited for identifying a particular magazine.

7. A medical treatment device according to claim 5,
characterized in that
said means is capable of identifying encodings and/or fixed encodings which can be stored in at least one transponder (2) fixedly arranged at said magazine (1) as data carrier element.

8. A medical treatment device according to claim 6,
characterized in that
said means is capable of identifying encodings and/or fixed encodings which can be stored in at least one transponder (2) fixedly arranged at said magazine (1) as data carrier element.

9. A medical treatment device according to claim 1,
characterized in that
said instrument (4i) is a dental drill, preferably an endo-drill.

10. A medical treatment device according to claim 1,
characterized in that
said foot-operable control unit (20) is adapted to be controlled by a foot-operable additional control unit (40) adapted to be connected to the former.

11. A medical treatment device according to claim 1,
characterized in that
a computer-aided data processing system (50) can be connected to the medical treatment device, preferably to said foot-operable control unit (20).

12. A medical treatment device according to claim 3,
characterized in that
said microcomputer (35) and/or said computer system (22) is/are provided for processing the data relating to the information of use.

13. A medical treatment device according to claim 1,
characterized in that
the data transmission between said handpiece (30) and said foot-operable control unit (20) is permitted via a connecting line (37).
